(19) United States
(12) Patent Application Publication
(10) Pub. No.: US 2006/0269711 A1
(43) Pub. Date: Nov. 30, 2006

(54) FLEXIBLE INTERMEDIATE BULK CONTAINER HAVING OPTIMUM DISCHARGE OF HAZARDOUS CHARGE

(75) Inventors: N. Satish Chandra, Lansdale, PA (US); William F. McNally, Clarks Summit, PA (US); Joseph Diehl, Avoca, PA (US)

Correspondence Address: AKERMAN SENTERFITT, P.O. BOX 3188, WEST PALM BEACH, FL, 33402-3188, US

(73) Assignee: Noble Fiber Technologies, LLC, Scranton, PA (US)

(21) Appl. No.: 11/421,310

(22) Filed: May 31, 2006

Related U.S. Application Data
(60) Provisional application No. 60/685,857, filed on May 31, 2005.

(51) Int. Cl. B29C 70/08

(52) U.S. Cl. 428/36.3

(57) ABSTRACT

A flexible intermediate bulk container having the ability to discharge hazardous charges without combustion, thereby enabling the container to contain incendiary materials without risk of combustion. The flexible intermediate bulk containers may permit safe handling of materials whether or not the materials are grounded. Unlike many prior art systems, the flexible intermediate bulk container need not include an anti-static coating to function, thereby resulting in cost savings. The electrostatic yarn of the present invention may be incorporated into any bag or container system without any modifications in the process. The electrostatic yarn may also be used in either flat or circular weave. The electrostatic yarn may also be included in fabrics other than containers or bags.

### CROSS-REFERENCE TO RELATED APPLICATION

This application claims the benefit of U.S. Provisional Application No. 60/685,857, filed May 31, 2005.

### FIELD OF THE INVENTION

This invention is directed generally to containers, and more particularly to flexible intermediate bulk containers (IBCs).

### BACKGROUND OF THE INVENTION

Containers formed of flexible fabric are used in commerce to carry free-flowable materials in bulk quantities. Flexible intermediate bulk containers (FIBC) have been utilized for a number of years to transport and deliver finely divided solids such as cement, fertilizers, salt, sugar, and barite, among others. Such bulk containers can be utilized for transporting almost any type of free-flowable finely divided solid. The fabric from which they are generally constricted is a weave of a polyolefin, e.g., polypropylene, which may optionally receive a coating of a similar polyolefin on one or both sides of the fabric. If such a coating is applied, the fabric is non-porous, while fabric without such coating is porous. The typical configuration of such flexible bulk containers is a rectilinear or cylindrical body having a wall, base, cover, and a closable spout secured to extend from the base or the top or both.

In many instances these containers are handled by placing the forks of a forklift hoist through loops attached to the container. It has been found that the shifting of specific materials within containers made of woven fabrics, as well as particle separation between the materials and such containers during loading and unloading of the container cause triboelectrification and create an accumulation of static electricity on the container walls. In addition, the accumulation of static electricity is greater at lower relative humidity and increases as the relative humidity decreases. Also, highly charged material entering flexible bulk containers can create an accumulation of static electricity on the container walls. Electrostatic discharges from a charged container can be incendiary, i.e. cause combustion in dusty atmospheres or in flammable vapor atmospheres. In addition, discharges can be uncomfortable to workers handling such containers.

One conventional solution has been use of grounded containers. These containers are often referred to as “C” containers. Such a container may include conductive fibers that are electrically connected to a ground to carry the electric energy out of the container. The use of a grounded container, however, works only as long as the container remains grounded. If the container becomes ungrounded, the container loses the ability to decrease the potential for an incendiary discharge, and due to the higher capacitance of the conductive system, the discharge can be much more energetic and incendiary than conventional non-conductive containers. Additionally, fabrication of the conductive containers requires specialized construction techniques to ensure all conductive surfaces are electrically connected together for a ground source.

Another conventional approach to decreasing the potential for incendiary discharges in flexible containers has been directed toward decreasing the surface electrostatic field of the container. If the magnitude of the electrostatic field on the surface of a container is above a certain threshold level, the potential for an incendiary discharge due to the electrostatic charge exists. That threshold level is about 500 kilovolts per meter (kV/m) for intermediate bulk containers made from woven polypropylene fabric. By decreasing the surface electrostatic field below about 500 kV/m, the potential for an incendiary discharge is greatly decreased and believed to be rendered virtually non-existent. Attempts at reducing the surface electrostatic field level below about 500 kV/m have not, however, proven successful without proper grounding.

One such effort at decreasing surface electrostatic fields has focused on the creation of corona discharges. There are four basic types of electrostatic discharges: spark discharges; brush discharges; propagating brush discharges; and, corona discharges. Of the four electrostatic discharges, the spark, the brush and the propagating brush electrostatic discharges can all create incendiary discharges. The corona discharge is not known to create incendiary discharges for common flammable atmospheres. By incorporating certain materials into the flexible fabric container as the electrostatic field increases, corona discharges from such materials limit the maximum field. This electrostatic field level, however, is above the 500 kV/m threshold level at which the potential for incendiary discharge first appears.

Other efforts are focused are using higher resistance containers, on the order of 10¹⁰ to 10¹² Ohms, such that the containers do not need to be grounded. These types of containers are referred to as “D” containers. While the type “D” containers do not need to be grounded, in use, everything around the container does need to be grounded, including equipment or workers, or both, or else the same risk of incineration exists as for “C” containers. Many of these containers achieve this higher resistivity through the use of coatings on the container. While the type “D” containers do not need to be grounded, the type “D” containers suffer from the same problems as the type “C” containers because all objects around the type “D” containers must be grounded.

Accordingly, a need exists for a flexible container that neither needs to be grounded nor requires persons or equipment, or both, near the flexible container to be grounded. Also, a need exists for a flexible container that is not dependent on humidity to discharge safely. Furthermore, a need exists for a flexible container having a lower resistance to produce an optimum discharge by attracting the field of charge to reduce the risk of explosion or fire due to a discharge of static electricity.

### SUMMARY OF THE INVENTION

The present invention is directed to a flexible container having optimum discharge of hazardous charges. The flexible container may provide an advanced method of electrostatic discharge (ESD) utilizing optimum resistivity, thereby resulting in the safe discharge of static electricity that may have accumulated in the flexible container. The invention utilizes a unique spun yarn system to provide the optimum resistance on the outside of a carrier yarn. The flexible container enables the optimum capture or safe dissipation of charges, or both. As a result, the flexible container may be used in any system because the flexible containers may or may not be grounded, depending on the particular system in which the flexible containers are used.

The flexible container may be formed from a container having a plurality of walls formed from an electrostatic yarn including a metallized higher resistance yarn and a carrier yarn. The metallized higher resistance yarn may include a blend of a low conductivity metal-coated fiber and a high conductivity metal-coated fiber and have a resistance of from about 10⁸ to about 10¹⁰ Ohms. The electrostatic yarn may be have between about one percent and about twenty percent by weight of the metallized higher resistance yarn and between about 80 percent and about 99 percent by weight of the carrier yarn.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a perspective view of a flexible bulk container of this invention.

FIG. 2 is a perspective view of a metallized higher resistance yarn formed from low and high conductivity metal-coated fibers.

FIG. 3 is a perspective detailed view of a combination of a metallized higher resistance yarn with a carrier yarn.

FIG. 4 is a perspective detailed view of a combination of a metallized higher resistance yarn with a strengthened yarn.

### DETAILED DESCRIPTION OF THE INVENTION

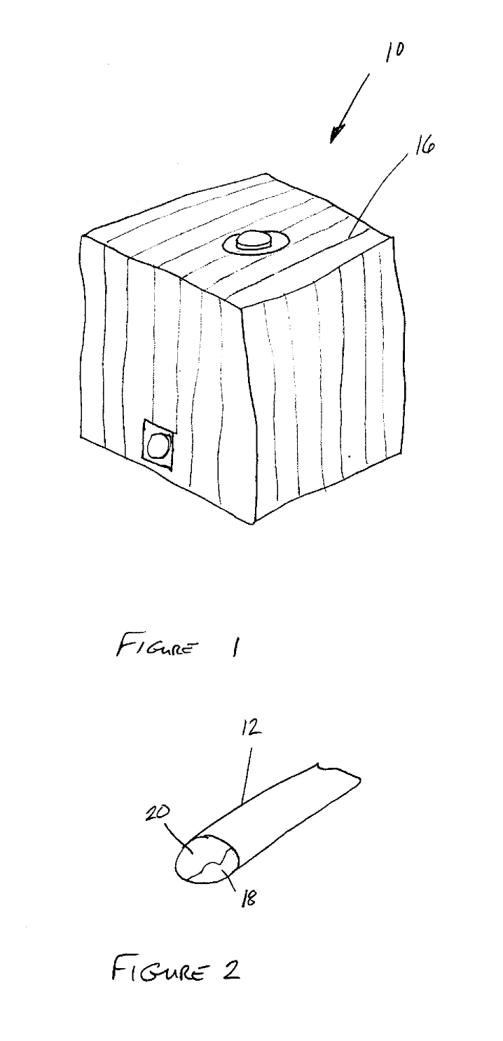

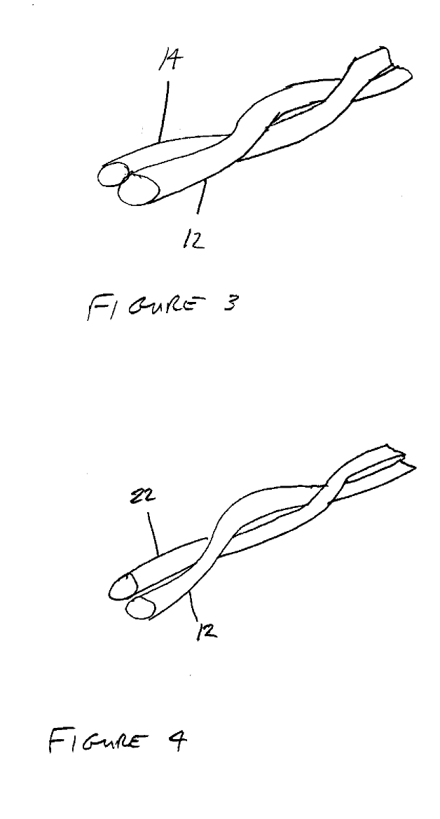

As shown in FIGS. 1-4, the invention is directed to a flexible container 10 that enables optimum discharge of hazardous charges without combustion of the materials contained with the flexible container. The flexible container 10 may be formed using a unique electrostatic yarn 16 that has increased resistance such that the flexible containers 10 need not be grounded. Nevertheless, the flexible container 10 may also be grounded in those systems in which it may be beneficial to ground the container 10. The electrostatic yarn 16 may include a metallized higher resistance yarn 12. As used herein, a “metallized higher resistance yarn” 16 may be any yarn having a metal thereon or therein and having a resistance in the range of from about 10⁸ to about 10¹⁰ Ohms. The typical denier per filament of the metallized higher resistance yarn 16 may between one and five denier. The electrostatic yarn 16 used in forming the flexible container 10 may be formed from a metallized higher resistance yarn 12 and a carrier yarn 14, as shown in FIG. 3. The metallized higher resistance yarn 12 and the carrier yarn 14 may be formed into the electrostatic yarn 16 using processes that reduce the cost of making the containers 10 or other fabrics.

The flexible container 10 may be formed by using an electrostatic yarn 16. The electrostatic yarn 16 may be formed such that the flexible container 10 have a plurality of corona discharge points. In at least one embodiment, the flexible container 10 may have several thousand corona discharge points along the container 10. As a result, in those embodiments wherein the resistance of the flexible container 10 is higher, the flexible container 10 may not be grounded. Conversely, in those embodiments in which the resistance of the flexible container 10 is lower, the flexible container 10 may be grounded. The resistance of the electrostatic yarn 16 is based, in part, on the amount of metallized higher resistance yarn 12 in the electrostatic yarn 16. Even though the metallized higher resistance yarn 12 has a higher resistance than typical metallized yarns, the metallized higher resistance yarn 12 generally has, in at least one embodiment, a lower resistance than the carrier yarns 14. Therefore, in these embodiments, as the amount of metallized higher resistance yarn 12 decreases, the total resistance of the flexible container 10 increases.

In one embodiment, the metallized higher resistance yarn 12 may be a blended metallized yarn. In this embodiment, as shown in FIG. 2, the metallized higher resistance yarn 12 may include a blend of a low conductivity metal-coated fiber 18 and a high conductivity metal-coated fiber 20. The low conductivity metal-coated fiber 18 may be selected to have a higher resistance. In one embodiment, the low conductivity metal-coated fiber 18 may have a resistance of about 10¹² Ohms or greater. The high conductivity metal-coated fiber 20 may be selected to have a higher resistance. In one embodiment, the high conductivity metal-coated fiber 20 may have a resistance of about 10⁸ Ohms or less. The blend of the low conductivity metal-coated fiber 18 and the high conductivity metal-coated fiber 20 results in a metallized higher resistance yarn 12 with a resistance between about 10⁸ and about 10¹⁰ Ohms. The metallized higher resistance yarn 12 may form a portion of the electrostatic yarn 16 forming the flexible containers 10 that are resistant to static discharge but need not be grounded, unlike prior art systems.

The amount of the low conductivity metal-coated fiber 18 blended with the high conductivity metal-coated fiber 20 may be any amount capable of resulting in a metallized higher resistance yarn 12 having a selected resistance. Factors for determining the amounts of each fiber 18, 20 to be used may include, but are not limited to, the resistance of the low conductivity metal-coated fiber 18, the resistance of the high conductivity metal-coated fiber 20, the selected resistance of the final blend forming the metallized higher resistance yarn 12, the intended use of the yarn 12, or whether the flexible container 10 is to be grounded or not, or a combination thereof. In one embodiment, the metallized higher resistance yarn 12 may include between about one percent and about 20 percent by weight of the low conductivity metal-coated fiber 18 and between about 80 percent and about 99 percent by weight of the high conductivity metal-coated fiber 20. In another embodiment, the metallized higher resistance yarn 12 may include between about two percent and about 10 percent by weight of the low conductivity metal-coated fiber 18 and between about 90 percent and about 98 percent by weight of the high conductivity metal-coated fiber 20.

The metal used in the low conductivity metal-coated fiber 18 or the high conductivity metal-coated fiber 20, or both, may be any metal capable of providing the selected resistance. In one embodiment, the metal may be silver. In alternative embodiments, the metal may include, but is not limited to, copper, aluminum, zinc, nickel, or the like, or blends, or combinations thereof.

The metallized higher resistance yarn 12 may, in general, have a low denier. As a result, the metallized higher resistance yarn 12, in some embodiments, may be combined with a strengthening yarn 22 of higher denier than the metallized higher resistance yarn 12, as shown in FIG. 4. The strengthening yarn 22 may enable increased strength of the overall system. In one embodiment, the strengthening yarn 22 may be a polypropylene yarn. In alternative embodiments, the strengthening yarn 22 may be other materials, such as polyethylene yarn and other appropriate materials.

The metallized higher resistance yarn 12 or strengthened yarns 22 may be combined with a carrier yarn 14 to form the electrostatic yarn 16. The carrier yarn 14 may be any type of yarn used in woven or non-woven fabrics. In general, the carrier yarns 14 may have a denier of between about 100 denier and about 1700 denier. A denier within this range permits flexibility of using the carrier yarns 14 in any kind of construction. It is to be recognized, however, that carrier yarns 14 having higher denier may also be used, depending on the final end use of the yarn or fabric. Any suitable carrier yarn 14 may be used in the present invention. Examples of carrier yarns 14 that may be used include, but are not limited to, poly(ethylene terephthalate) (PET) yarn, poly(trimethylene terephthalate) (PTT) yarn, cotton yarn, wool yarn, polyester yarn, polyamide yarn, polyacrylic yarn, polyvinyl yarn, polypropylene yarn, hemp, silk, a regenerated cellulose yarn, rayon, polynosic, an acetate yarn, nylon fibers, or a combination thereof.

The electrostatic yarn 16 may be formed using a combination of the metallized higher resistance yarn 12 and the carrier yarn 14. Factors for determining the amounts of each yarn 12, 14 to be used to form the electrostatic yarn 16 may include, but are not limited to, the selected resistance of the final electrostatic yarn 16, the intended use of the electrostatic yarn 16, whether any resulting flexible container 10 is to be grounded or not, the amount of corona discharge points along the yarn, or a combination thereof. In one embodiment, the electrostatic yarn 16 includes between about one percent and about 25 percent by weight of the metallized yarn and between about 75 percent and about 99 percent by weight of the carrier yarn 14. In another embodiment, the electrostatic yarn 16 may include between about five percent and about 15 percent by weight of the metallized high resistance yarn 12 and between about 85 percent and about 95 percent by weight of the carrier yarn 14.

The metallized high resistance yarn 12 or strengthened metallized yarns 22 may be combined with the carrier yarn 14 using different processes to facilitate different properties of the electrostatic yarn 16. In a first embodiment, the electrostatic yarn 16 may be formed by twisting the metallized high resistance yarn 12 to roll off on to the carrier yarn 14 to result in placing it on the outside of the carrier yarn 14. This is different than regular twisting where there is no control of where the metallized high resistance yarn 12 can be incorporated in to the carrier yarn 16. In another alternative embodiment, the electrostatic yarn 16 may be formed by forming the metallized high resistance yarn 12 into an “X” pattern using a technique referred to as “wrapping.” In this technique, two ends of metallized high resistance yarn 12 may be twisted on the outside of the carrier yarn 14 to produce an “X” effect. In yet another alternative embodiment, only one end may include the metallized high resistance yarn 12, with the other end including a generic yarn of equal denier. The reduced usage of the metallized high resistance yarn 12 reduces the cost of the electrostatic yarn 16.

The electrostatic yarn 16 may be incorporated into the flexible container 10 or other fabric. If the weave forming the flexible container 10 is flat, the electrostatic yarn 16 may be woven in the warp manner and spaced between about one inch and about five inches apart. In a fill or weft weave, the electrostatic yarn may be incorporated at a distance between about three inches and about 18 inches unlike “C” container yarn specifications, which are much closer. In a weft weave, the electrostatic yarn 16 may be tied together to facilitate grounding of bag if desired, although it is to be understood that the flexible container 10 is not required to be grounded. The same configuration may be applied to a circular weave hut by introducing the electrostatic yarn 16 only in the warp direction. The electrostatic yarn 16 may be tied up using seam tape of high resistance that enables grounding the flexible container 10 if desired, although, again, it is to be understood that the flexible container 10 is not required to be grounded.

The electrostatic yarn 16 may be formed into fabrics and other woven and non-woven materials using techniques well known in the art. For example, for a woven fabric, the electrostatic yarn 16 may be interwoven on a textile loom to form a sheet-like material relatively free of interstices. The tightness of the weave may be selected based upon a variety of different factors including, but not limited to, the end use of the container. For example, where the fabric is to be used to form flexible containers 10 for holding large particle size bulk material such as tobacco or pellets, then a fairly open weave of mono or multifilament yarn may be used in a count range of from about 1000 denier to 3000 denier in each weave direction.

The overall resistance of the fabrics or containers 10 or both may be from about 10⁷ to about 10¹⁴ Ohms. The resistance is not low enough to require that the flexible containers 10 be grounded at all times. It is also not so high that it is difficult to check the resistance of each flexible container 10 to ensure safety.

While the present invention has been described in relation to its use in flexible containers 10, other applications are envisioned. Examples of other applications include, but are not limited to, pneumatic conveyor tubes, gravity slides, clothing to be worn by individuals working around flammable or incendiary materials, or liners in containment vessels. In addition, the electrostatic yarns 16 may be used in any application in which it may be advantageous to have an anti-microbial effect for the flexible container 10 as well as a reduction in static discharge potential. Silver is able to kill all pathogenic microorganisms, and no organism has ever been reported to readily develop resistance to it. One such example where such a material may be useful is in a hospital environment, such as in environments having oxygen gas nearby.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. A flexible container, comprising:
an electrostatic yarn comprising a metallized yarn and a carrier yarn;
wherein the metallized yarn comprises a blend of a low conductivity metal-coated fiber and a high conductivity metal-coated fiber;
further wherein the metallized yarn has a resistance of between about 10⁸ to about 10¹⁰ Ohms.

2. The flexible container of claim 1, wherein the metallized yarn comprises between about one percent and about 20 percent by weight of the low conductivity metal-coated fiber and between about 80 percent and about 99 percent by weight of the high conductivity metal-coated fiber.

3. The flexible container of claim 2, wherein the metallized yarn comprises between about two percent to about 10 percent by weight of the low conductivity metal-coated fiber and between about 90 percent to about 98 percent by weight of the high conductivity metal-coated fiber.

4. The flexible container of claim 1, wherein the low conductivity metal-coated fiber comprises silver-coated fiber that provides antimicrobial capabilities to the flexible container.

5. The flexible container of claim 1, wherein the high conductivity metal-coated fiber comprises silver-coated fiber that provides antimicrobial capabilities to the flexible container.

6. The flexible container of claim 1, wherein the low conductivity metal-coated fiber has a resistance of about 10¹² Ohms or greater.

7. The flexible container of claim 1, wherein the high conductivity metal-coated fiber has a resistance of about 10⁸ Ohms or less.

8. The flexible container of claim 1, wherein the carrier yarn is selected from the group consisting of poly(ethylene terephthalate) yarn, poly(trimethylene terephthalate) yarn, cotton yarn, wool yarn, polyester yarn, polyamide yarn, polyacrylic yarn, polyvinyl yarn, polypropylene yarn, hemp, silk, a regenerated cellulose yarn, rayon, polynosic, an acetate yarn, nylon fibers, and combinations thereof.

9. The flexible container of claim 1, further comprising a plurality of electrostatic yarns spaced apart from each other a distance of between about 1.5 inches and about four inches.

10. The flexible container of claim 1, further comprising a plurality of electrostatic yarns spaced apart from each other a distance of between about five inches and about 18 inches.

11. The flexible container of claim 1, wherein the electrostatic yarn comprises between about one percent and about 25 percent by weight of the metallized yarn and between about 75 percent and about 99 percent by weight of the carrier yarn.

12. The flexible container of claim 11, wherein the electrostatic yarn comprises between about five percent and about 15 percent by weight of the metallized yarn and between about 85 percent and about 95 percent by weight of the carrier yarn.

13. An electrostatic yarn, comprising:
between about one percent and about 20 percent by weight of a metallized yarn and between about 80 percent and about 99 percent by weight of a carrier yarn;
wherein the electrostatic yarn has a resistance of between about 10⁸ to about 10¹⁰ Ohms;
wherein the metallized yarn comprises between about one percent and about 20 percent by weight of the low conductivity metal-coated fiber and between about 80 percent and about 99 percent by weight of the high conductivity metal-coated fiber.

14. The electrostatic yarn of claim 13, wherein the metallized yarn comprises between about two percent and about 10 percent by weight of the low conductivity metal-coated fiber and between about 90 percent and about 98 percent by weight of the high conductivity metal-coated fiber.

15. The electrostatic yarn of claim 13, wherein the low conductivity metal-coated fiber comprises silver-coated fiber that provides antimicrobial capabilities to the flexible container.

16. The electrostatic yarn of claim 13, wherein the high conductivity metal-coated fiber comprises silver-coated fiber that provides antimicrobial capabilities to the flexible container.

17. The electrostatic yarn of claim 13, wherein the low conductivity metal-coated fiber has a resistance of about 10¹² Ohms or greater.

18. The electrostatic yarn of claim 13, wherein the high conductivity metal-coated fiber has a resistance of about 10⁸ Ohms or less.

19. The electrostatic yarn of claim 13, wherein the carrier yarn is selected from the group consisting of poly(ethylene terephthalate) yarn, poly(trimethylene terephthalate) yarn, cotton yarn, wool yarn, polyester yarn, polyamide yarn, polyacrylic yarn, polyvinyl yarn, polypropylene yarn, hemp, silk, a regenerated cellulose yarn, rayon, polynosic, an acetate yarn, nylon fibers, and combinations thereof.

20. The electrostatic yarn of claim 13, wherein the electrostatic yarn comprises between about five percent and about 15 percent by weight of the metallized yarn and between about 85 percent and about 95 percent by weight of the carrier yarn.
